(19) United States
(12) Patent Application Publication
(10) Pub. No.: US 2002/0181710 A1
(43) Pub. Date: Dec. 5, 2002

(54) Mobile transaction system and method

(76) Inventors: Kfir Adam, Oranit (IL); Shmuel Blit, Rehovot (IL); Adl Eckstein, Raanana (IL); Boaz Inbal, Ramat-Hasharon (IL)

Correspondence Address: William H Dippert, Cowan Liebowitz & Latman, 1133 Avenue of the Americas, New York, NY, 10036-6799, US

(21) Appl. No.: 10/030,763

(22) PCT Filed: Feb. 15, 2001
(86) PCT No.: PCT/IL01/00097

(30) Foreign Application Priority Data
Feb. 27, 2000 (IL) 134741

(51) Int. Cl. H04K 1/00

(52) U.S. Cl. 380/270

(57) ABSTRACT

A transaction system and method for conducting financial transactions, cooperating with a mobile telephony network adapted to provide telephony services to a plurality of mobile phones is disclosed. The system comprises: an administrating server adapted to administer accounts of merchants and customers, and adapted to communicate at a given time with at least one of the plurality of mobile phones of a customer via the mobile telephony network; at least one of a plurality of communication units which are located at merchants' point of sale adapted to communicate with said administrating server; wherein the communication unit is adapted to identify the mobile phone, and adapted to communicate to said administrating server a first communication message comprising transaction details, identifying the merchant, the customer and specifying an amount to be paid; wherein said administrating server is adapted to communicate the transaction details in a second communication message via the mobile telephony network to the mobile phone for authorization by the customer, and adapted to receive authorization from the customer in a third communication message from the mobile phone via the mobile telephony network; wherein said administrating unit is further adapted to communicate a transaction authorization in a fourth communication message to said communication unit; wherein said communication unit is adapted to finalize the transaction by communicating a fifth communication message to said administrating server; and wherein said administrating server is adapted, after receiving the finalizing message to debit the customer's account in the amount to be paid and credit the merchant's account accordingly.

### FIELD OF THE INVENTION

The present invention relates to a system and method of financial transactions, and more particularly to a system and method of financial transactions using mobile phones.

### BACKGROUND OF THE INVENTION

Most of today's commercial transactions involve four types of payment: cash, cheques, credit cards and debit cards.

Alternative methods of payments were introduced aimed for specific groups, such as consumer club cards and also for specific environments, such as e-commerce specifically adapted for internet (web) transactions. There exist various types of transaction methods used on the web. One method involves the involvement of a “clearing house” where the customer establishes an account with the clearing house, submitting his or hers credit details to the clearing house, and obtaining verifying code or password (in fact the password is not revealed to the merchant rather he receives confirmation from the clearing house) which is them used when the customer wishes to perform a transaction. The merchant, when approached by the customer, verifies his code and password and if cleared the transaction is accomplished. Other methods involve supplying the buyers credit details over a secured page, faxing the credit details using a fax machine or simply delivering these details over the phone.

Cellular phones (hereafter referred to as cellular phones or mobile phones) have substantially grown in numbers in recent years and are spreading rapidly to become an item everyone owns. It is common to observe people carrying around cellular phones and using them extensively. The availability of cellular phones and their widespread distribution together with the realization that cellular phones are in fact sophisticated communication devices led to the introduction of m-commerce (mobile commerce)—cellular phones as means for conducting payments.

An example for a payment method and apparatus using cellular phones is disclosed in PCT patent application titled TELEDATA COMMUNICATION PAYMENT METHOD AND APPARATUS, to Hultgren (WO 98/47116). A tele/data communications network has a service node (TSN) which facilitates payment or transfer from a customer account of a customer financial institution to a merchant account of a merchant financial institution. The TSN acquires a merchant identifier and transaction amount from a customer mobile station. The TSN sends a transaction verification request message to both the mobile station and the merchant terminal. Upon receipt of transaction verification, the TSN requests transfer of the transaction amount from the customer account to the merchant account. It is apparent from the above mentioned patent disclosure that the TSN must handle a plurality of messages, especially with the customer's mobile station. Moreover, the system is heavily dependant on the central network interface, which governs and conducts the transaction (actually the TSN merely conducts the communication between the involved entities).

It is desirable (or at least regarded as such) that the transaction details (merchant's identification, customer's identification, amount to be paid) be presented to the customer as a batch, be approved by the customer and forwarded to the transaction administrator, in order to fulfil transaction standards, regarding

It is a purpose of the present invention to provide a novel payment system and method, based on a plurality of mobile terminals.

Another purpose of the present invention is to provide such a payment system and method that utilizes the distribution of cellular phones and use them as mobile terminals

Yet another purpose of the present invention is to provide a payment system and method that minimizes the amount of messages transmitted between the customer, merchant and the network server, in particular wireless messages.

Further purpose of the present invention is to provide such transaction method and system which centralizes the administration of the merchant's and customer's accounts.

Another purpose of the present invention, in a preferred embodiment of the present invention, is to provide a system's user application that can be stored on a SIM card, thus allowing it to be quickly installed and uninstalled in any cellular phone operating with a SIM card.

### BRIEF DESCRIPTION OF THE INVENTION

There is thus provided, in accordance with a preferred embodiment of the present invention, a transaction system for conducting financial transactions, cooperating with a mobile telephony network adapted to provide telephony services to a plurality of mobile phones, said system comprising:

an administrating server adapted to administer accounts of merchants and customers, and adapted to communicate at a given time with at least one of the plurality of mobile phones of a customer via the mobile telephony network;

at least one of a plurality of communication units which are located at merchants' point of sale adapted to communicate with said administrating server;

wherein the communication unit is adapted to identify the mobile phone, and adapted to communicate to said administrating server a first communication message comprising transaction details, identifying the merchant, the customer and specifying an amount to be paid;

wherein said administrating server is adapted to communicate the transaction details in a second communication message via the mobile telephony network to the mobile phone for authorization by the customer, and adapted to receive authorization from the customer in a third communication message from the mobile phone via the mobile telephony network;

wherein said administrating unit is further adapted to communicate a transaction authorization in a fourth communication message to said communication unit;

wherein said communication unit is adapted to finalize the transaction by communicating a fifth communication message to said administrating server;

and wherein said administrating server is adapted, after receiving the finalizing message to debit the customer's account in the amount to be paid and credit the merchant's account accordingly.

Furthermore, in accordance with another preferred embodiment of the present invention, the mobile telephony network is a GSM network.

Furthermore, in accordance with another preferred embodiment of the present invention, mobile phone is adapted to cooperate in said system by means of an application program which is a built-in hardware application or a software application.

Furthermore, in accordance with another preferred embodiment of the present invention, the mobile phone is adapted to cooperate in said system by means of an application program which is a built-in hardware application or a software application stored on a memory of the mobile phone memory or on a SIM card.

Furthermore, in accordance with another preferred embodiment of the present invention, the application program stores permanently personal parameters of the customer such as the customer's identification details, and enables sending and receiving wireless data communications and Inputting data through a keypad of the mobile phone, and viewing messages on a display of the mobile phone.

Furthermore, in accordance with another preferred embodiment of the present invention, communication between said administrating server and the mobile phone is conducted using SMS protocol.

Furthermore, in accordance with another preferred embodiment of the present invention, communication between said administrating server and the mobile phone is conducted using WAP protocol.

Furthermore, in accordance with another preferred embodiment of the present invention, the communication unit is adapted to identify the mobile phone by receiving an ID number from the customer.

Furthermore, in accordance with another preferred embodiment of the present invention, the communication unit is adapted to identify the mobile phone by receiving an ID number from the customer, who enters the ID number directly into said communication unit.

Furthermore, in accordance with another preferred embodiment of the present invention, the communication unit is adapted to identify the mobile phone by receiving an identifying RF signal from the mobile phone.

Furthermore, in accordance with another preferred embodiment of the present invention, the communication unit is adapted to identify the mobile phone by receiving an identifying arbitrary code or number generated by the mobile phone or by the administrating server, and transmitted to the administrating server for verification.

Furthermore, in accordance with another preferred embodiment of the present invention, the communication unit is adapted to identify the mobile phone by providing the mobile phone with identifiable feature or features, and providing said communication unit with suitable identifying means for receiving the identifiable features.

Furthermore, in accordance with another preferred embodiment of the present invention, the identifiable feature is a barcode, and the identifying means comprise barcode reader.

Furthermore, in accordance with another preferred embodiment of the present invention, the identifiable feature is a signal in the audio range, and the identifying means comprise audio receiver.

Furthermore, in accordance with another preferred embodiment of the present invention, said administrating server and communication unit intercommunicate through a point-to-point line or telephone lines or wireless communication link.

Furthermore, in accordance with another preferred embodiment of the present invention, the fifth communication message is carried out instantly.

Furthermore, in accordance with another preferred embodiment of the present invention, the fifth communication message is carried out after a predetermined number of transactions have been performed.

Furthermore, in accordance with another preferred embodiment of the present invention, the fifth communication message is carried out after a predetermined time has elapsed.

Furthermore, in accordance with another preferred embodiment of the present invention, the fifth communication message is carried out after a predetermined sum of transactions has been reached.

Furthermore, in accordance with another preferred embodiment of the present invention, the accounts of merchants and customers are managed in financial institutes, such as banks, credit providing companies and the like.

Furthermore, in accordance with another preferred embodiment of the present invention, said administrating server comprises communication interface to the mobile telephony network, a database which merchants' and customers' details, balance, credit limitations and any additional information details are stored, archive in which past transaction information is stored for reference, communication interface adapted to facilitate communication between the administrating server to a plurality of merchant communication units, and a processing unit adapted to manage the merchant's and customer's accounts, and communicate with the communication units and with customers mobile phones.

Furthermore, in accordance with another preferred embodiment of the present invention, communications between said administrating server and the communication unit are conducted via the internet.

Furthermore, in accordance with another preferred embodiment of the present invention, said communication unit comprises communication interface to the mobile telephony network, communication interface to the plurality of merchants' POSs, database 37 for storing transaction information locally (such as transaction documentation required by law, or information for later proof of purchase), an optional printer 35, for printing out receipts or other forms of purchase proof, to be handed to the customer for his reference, or for the merchant's documentation, and a processing unit which processes the information in the manner previously explained. A user interface 34, such as a keyboard, or similar input device, is provided for inputting necessary transaction details (primarily the transaction amount to be paid, but also other desired optional information too).

Furthermore, in accordance with another preferred embodiment of the present invention, there is provided a transaction system for conducting financial transactions, cooperating with a first mobile telephony network adapted to provide telephony services to a plurality of mobile phones and at least one of a plurality of mobile phones of visitors originally registered with a second mobile telephony network, said system comprising:

a first administrating server adapted to administer accounts of merchants and customers, and adapted to communicate at a given time with at least one of the plurality of mobile phones of a customer via the mobile telephony network,

a second administrating server similar to the first administrating server, operating in the second mobile telephony network, administering accounts of the visitors and adapted to communicate with said first administrating server;

at least one of a plurality of communication units which are located at merchants' point of sale adapted to communicate with said first administrating server;

wherein the communication unit is adapted to identify the visitor's mobile phone, and adapted to communicate to said first administrating server a first communication message comprising transaction details, identifying the merchant, the visitor and specifying an amount to be paid;

wherein said first administrating server is adapted verify the visitors identification details and balance with the second administrating server, to communicate the transaction details in a second communication message via the mobile telephony network to the visitor's mobile phone for authorization by the visitor, and adapted to receive authorization from the visitor in a third communication message from the mobile phone via the mobile telephony network;

wherein said first administrating unit is further adapted to communicate a transaction authorization in a fourth communication message to said communication unit,

wherein said communication unit is adapted to finalize the transaction by communicating a fifth communication message to said first administrating server;

and wherein said first administrating server is adapted, after receiving the finalizing message to communicate with said second administrating server and facilitate debiting the visitor's account in the amount to be paid and credit the merchant's account accordingly.

Furthermore, in accordance with another preferred embodiment of the present invention, said communication unit is adapted to identify the mobile phone by way of supplying identification details to said communication unit via the internet.

Furthermore, in accordance with another preferred embodiment of the present invention, the mobile phone is provided with internet browsing capability.

Furthermore, in accordance with another preferred embodiment of the present invention, there is provided a method of conducting transactions, incorporating with a mobile telephony network adapted to provide telephony services to a plurality of mobile phones, said method comprising the steps of

1. providing an administrating server adapted to administer accounts of merchants and customers, and adapted to communicate at a given time with at least one of the plurality of mobile phones of a customer via the mobile telephony network;

2. providing at least one of a plurality of communication units which are located at merchants' point of sale adapted to communicate with said administrating server;

3. identifying of the mobile phone by said communication unit;

4. communicating a first communication message comprising transaction details, identifying the merchant, the customer and specifying an amount to be paid from said communication unit to said administrating server;

5. communicating the transaction details in a second communication message from the administrating server via the mobile telephony network to the mobile phone for authorization by the customer, and receiving authorization from the customer in a third communication message from the mobile phone via the mobile telephony network to said administrating server;

6. communicating a transaction authorization in a fourth communication message to from said administrating server said communication unit;

7. finalizing the transaction by communicating a fifth communication message from said communication unit to said administrating server;

8. debiting the customer's account in the amount to be paid and crediting the merchant's account accordingly

Furthermore, in accordance with another preferred embodiment of the present invention, communicating between said administrating server and the mobile phone is conducted using SMS protocol.

Furthermore, in accordance with another preferred embodiment of the present invention, communicating between said administrating server and the mobile phone is conducted using WAP protocol.

Furthermore, in accordance with another preferred embodiment of the present invention, the step of identifying of the mobile phone by said communication unit is carried out by receiving an ID number from the customer.

Furthermore, in accordance with another preferred embodiment of the present invention, the step of identifying of the mobile phone by said communication unit is carried out by receiving an ID number from the customer, by him directly entering his ID into said communication unit.

Furthermore, in accordance with another preferred embodiment of the present invention, the step of identifying of the mobile phone by said communication unit is carried out by receiving an identifying RF signal from the mobile phone.

Furthermore, in accordance with another preferred embodiment of the present invention, the step of identifying of the mobile phone by said communication unit is carried out by receiving identifying arbitrary code or number generated by the mobile phone or by the administrating server, and transmitted to the administrating server for verification

Furthermore, in accordance with another preferred embodiment of the present invention, the step of identifying of the mobile phone by said communication unit is carried out by providing the mobile phone with identifiable feature or features, and providing said communication unit with suitable identifying means for receiving the identifiable features.

Furthermore, in accordance with another preferred embodiment of the present invention, the step of identifying of the mobile phone by said communication unit is carried out by supplying identification details to said communication unit via the internet

Furthermore, in accordance with another preferred embodiment of the present invention, communications between said administrating server and the communication unit are conducted via the internet.

Finally, in accordance with another preferred embodiment of the present invention, there is provided a method of conducting transactions, incorporating with a first mobile telephony network adapted to provide telephony services to a plurality of mobile phones and visitors mobile phones, originally registered to a second mobile telephony network, said method comprising the steps of:

1. providing a first administrating server adapted to administer accounts of merchants and customers, and adapted to communicate at a given time with at least one of the plurality of mobile phones of a customer via the mobile telephony network;

2. providing a second administrating server similar to the first administrating server, operating in the second mobile telephony network, administering accounts of the visitors and adapted to communicate with said first administrating server;

3. providing at least one of a plurality of communication units which are located at merchants' point of sale adapted to communicate with said first administrating server;

4. identifying the visitor's mobile phone by said communication unit;

5. communicating a first communication message comprising transaction details, identifying the merchant, the visitor and specifying an amount to be paid from said communication unit to said first administrating server;

6. verifying the visitors identification details and balance with the second administrating server;

7. communicating the transaction details in a second communication message from said first administrating server via the first mobile telephony network to the visitor's mobile phone for authorization by the visitor;

8. authorizing the transaction by the visitor in a third communication message from the mobile phone via the first mobile telephony network to said first administrating server;

9. communicating from said first administrating server a transaction authorization in a fourth communication message to said communication unit;

10. finalizing the transaction by communicating a fifth communication message from said communication unit to said first administrating server;

11. communicating between said first administrating server with said second administrating server and facilitating debiting the visitor's account in the amount to be paid and credit the merchant's account accordingly.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention as defined in the appending claims Like components are denoted by like reference numerals.

FIG. 1 illustrates a schematic diagram of a mobile transaction system in accordance with a preferred embodiment of the present invention

FIG. 2 illustrates a schematic diagram of a mobile transaction system in accordance with another preferred embodiment of the present invention.

FIG. 3 illustrates a schematic diagram of an administrating server, referred to as CSC (Cellular Service Center).

FIG. 4 illustrates a schematic diagram of a mobile transaction system in accordance with yet another preferred embodiment of the present invention.

FIG. 5 is a schematic diagram of a mobile transaction system in accordance with yet another preferred embodiment of the present invention, designed for Internet (or similar network) transactions

FIG. 6 depicts a block diagram of typical design for a point-of-sale in a mobile transaction system in accordance with a preferred embodiment of the present invention, cooperating with a cash register.

FIG. 7 depicts a block diagram of typical design for a point-of-sale in a mobile transaction system in accordance with a preferred embodiment of the present invention.

FIG. 8 illustrates a block diagram showing a design for a mobile phone to be used in accordance with the present invention.

FIG. 9 illustrates international application of the mobile transaction method of the present invention.

FIG. 10 illustrates a schematic diagram of a mobile transaction system in accordance with yet another preferred embodiment of the present invention, designed for Internet (or similar network) transactions.

FIG. 11 illustrates a schematic diagram of a mobile transaction system in accordance with yet another preferred embodiment of the present invention, designed for Internet (or similar network) transactions, with the mobile phone used as a browsing platform

### DETAILED DESCRIPTION OF THE INVENTION AND FIGURES

### GLOSSARY

The following abbreviations and acronyms will be used throughout this patent application:

CGG—Cellular GSM/wireless Gateway

CR—Cash Register

CSC—Cellular Service Center

GSM—Global System for Mobile Communication

ID—Identification

LCD—Liquid Crystal Display

ME—customer's Mobile Equipment i.e. cellular phone

POS—Point of Sale

QN—Queue number

RF—Radio Frequency

SMS—Short message service

SMSC—Short message service center

S/W—software

TCP/IP—Transmission Control Protocol/Internet protocol

WAP—Wireless Application Protocol

A main aspect of the present invention is the introduction of a novel payment method, involving a mobile phone network, and allowing customers to purchase goods and services by using a mobile phone.

Although suitable for all mobile communication networks, such as cellular telephony networks, satellite communication networks etc., the embodiments described herein, by way of examples, deal with a cellular telephony network, for the purpose of brevity and simplicity. This in no way limits the scope of the invention with respect to other forms of mobile communication networks.

The basic concept of the present invention is that mobile phones are communication means that are widely spread, and it is apparent that their owners tend to have their mobile phones at their disposal almost at all times (similarly to wallets).

A customer desires to buy an item or receive a service rendered by a certain merchant. The customer is equipped with Mobile Equipment (ME), usually a cellular phone, provided with Cellular application mode (either as hardware or software), which together constitute the CEP (Cellular Electronic Purse), registered to and adapted to communicate with a cellular network, and is preassigned with a personal identification number (PIN). The merchant's Point-Of-Sale is adapted to communicate with that same cellular network, and is preassigned a unique identification number, referred to as the Cash Register (CR) number. Note that the term “purse” is used here merely for illustrative purpose, yet there are no payment means literally within the CEP.

An administrating server, hereafter referred to as CSC (Cellular Service Center), that controls the transactions carried out by the customers and merchants subscribed to this service, is adapted to communicate via the cellular network with both customer and merchant.

The system and method of the present invention will become clear and better appreciated with reference to the accompanying Figures.

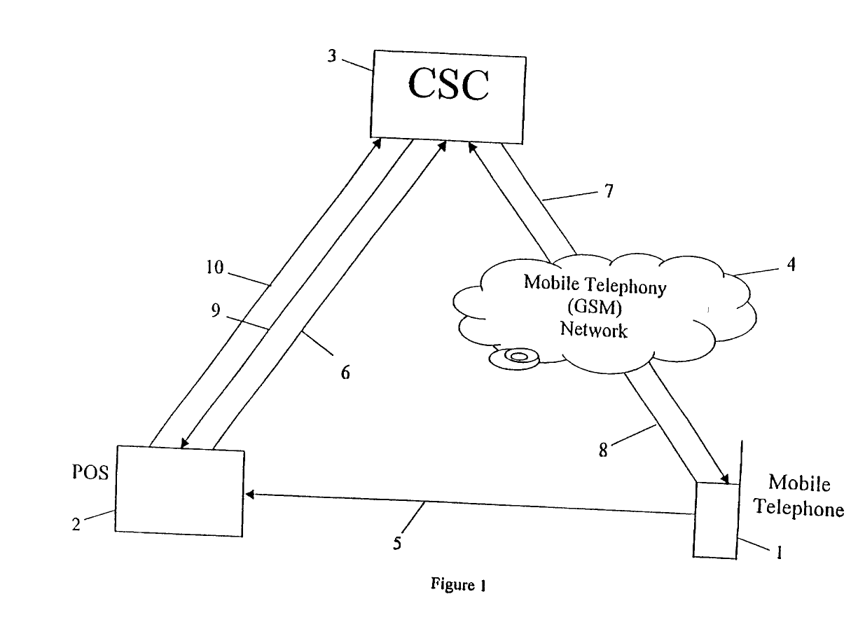

Reference is made to FIG. 1, which illustrates a schematic diagram of a mobile transaction system in accordance with a preferred embodiment of the present invention.

A customer equipped with a mobile phone 1, which is one of a plurality of mobile phones operating in a mobile telephony network 4, encounters a merchant's shop or place of business. Upon deciding to purchase a good or a service from that merchant, he (or she) first chooses to pay through his mobile transaction service. Mobile phone 1 is adapted to operate in the mobile transaction system of the present invention, having a suitable application that may be a built-in application of the phone's hardware, or software application, stored on the phone's memory, or on a SIM card. The telephony network described in the embodiments discussed herein (with reference to the Figures) is a GSM telephony network. The GSM network is given only as an example, and other telephony networks may be considered suitable for employing the transaction system and method of the present invention.

Cellular phones operating in GSM systems generally include a SIM card, which is adapted to be installed in the phone or be uninstalled and may be inter-replaceable with other cellular phones operating on the same network, which contains unique identification (such as the phone number of the phone, saved information, such as preferred phone numbers and address book), and may additionally contain other software applications, such as the cellular transaction application of the present invention. Cellular software may be stored on the SIM Card as defined in the GSM standards with STK-SIM application Tool Kit. In other cellular networks it may be implemented by other mechanisms that enable the required changes in the user interface and software of the mobile equipment to be made. The Cellular application software stores permanently personal parameters of the customer such as customer's ID with the cellular transaction service. The Cellular software enables sending and receiving wireless data and Inputting data through the phone's keypad, and viewing messages on the mobile's display.

Another suitable communication protocol for the present invention is WAP, which allows transmitting messages to and from mobile phones operating on WAP, and also implant, and change software applications on these mobile phones.

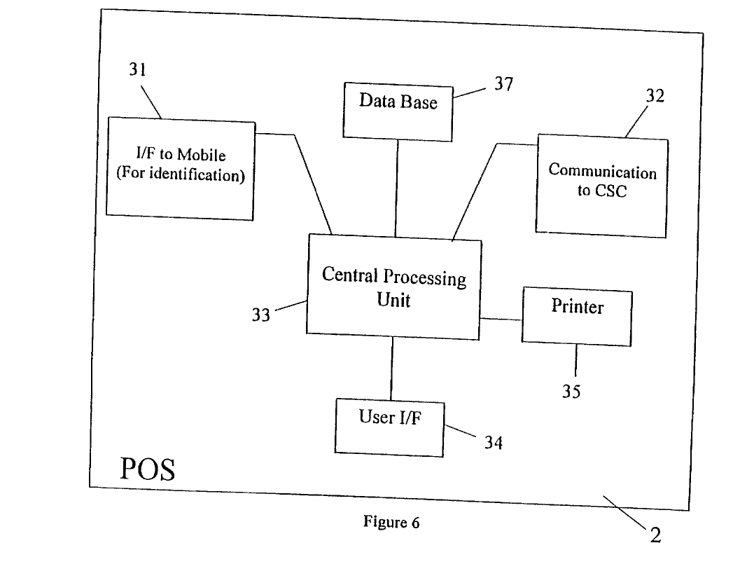

The merchant, on his side, is provided with a point-of-sale device, which is a cellular GMS gateway, adapted to communicate and operate with the other featured devices in the transaction system of the present invention (See FIG. 6).

First, the customer identifies himself 5 providing to the merchant's point-of-sale (POS) 2 an ID number previously assigned to him and kept with the administrating server This first step is a first precautionary measure taken in the system and method of the present invention in order to avoid repudiation at a later stage It is imperative that any transaction system and method be repudiation-safe, and the present invention discloses such system and method.

Any form of identification may be used, and some examples are given herein The customer may present his ID number to the merchant—this identification form is somewhat inconvenient as it is desirable to keep one's ID number secret, and giving it to the merchant increases the risk of it being exposed to unauthorized use. The customer may also ask the merchant to input his ID directly into the POS so as to provide the customer with the desired privacy. Altogether different approach is to provide the mobile phone with some identifiable feature or features, and provide the POS with suitable identifying means for receiving these identifiable features. This can be accomplished, for example, by providing the mobile phone with a barcode or any other visually identifiable feature or any identifiable signal in the audio range and providing the POS with a reader suitable for reading barcodes or identifying the visually or audio identifiable feature. Another identification form can be the transmission of radio frequency (RF) ID signal and receiving it by a receiver provided in the POS. This latter identification form may prove prone to malfunctions or inadequate in a scenario with multiple POSs, such as is the case with big hardware stores where many points of sale are present.

The identification may be in the form of the customer presenting the merchant with an identification number or code or any other identification details. However, this form is undesirable, since it is prone to frauds, allowing an imposter to present someone else's identification details On the other hand, due to the nature of the transaction method of the present invention described herein this risk is eliminated (or greatly reduced), for during the transaction process the customer's mobile phone receives transaction request information and is asked to authorize the transaction by sending an authorization message.

Yet another identification form may be the generation, within the mobile phone or by the administrating server or the communication unit, of an arbitrary identification code or number (such as a queue number—QN) that is transmitted to the CSC for verification as well as presented on the phone display, so that the customer may give it to the merchant.

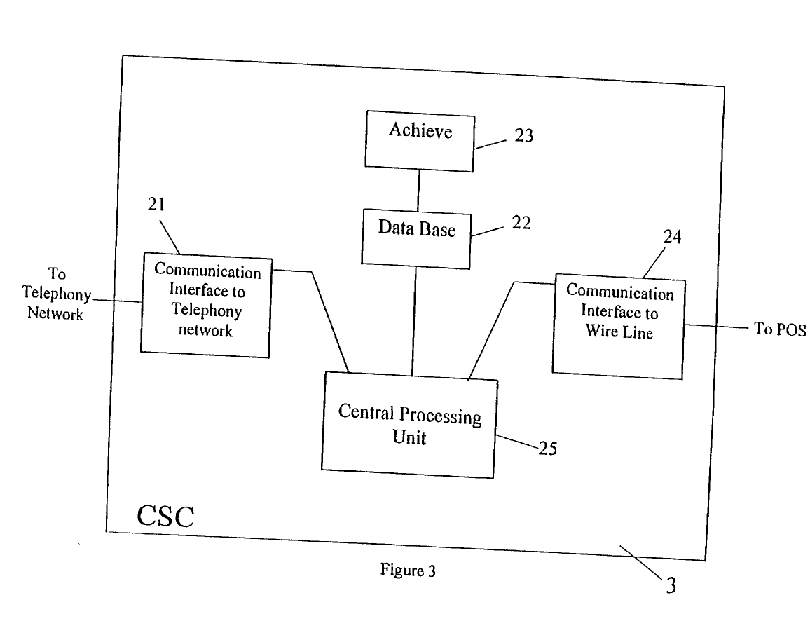

Once the POS has received the customer's (or his mobile phone) identification details, a first data communication message 6 containing the customer's ID, the merchant's ID (also previously assigned to him by the administrator of the system), and the sum to be paid (all hereafter referred to as “the transaction details”), is transmitted to an administrating server, which administers the mobile transactions of its subscribers (the customer and the merchants are both previously subscribed to this server), and whose features are described with reference to FIG. 3.

This first data communication message, as well as all other communication messages between the CSC and the POS, is sent via any available communication link. This may be a direct point-to-point line, as well as any other communication link, such as telephone lines, wireless communication, internet communication etc. Since the POS is located in a fixed location (the merchant's place of business) it is possible, and even desirable, to use direct fast communication lines, such as telephone lines or a point-to-point link, that provide relatively fast communication.

The administrating server 3, hereafter referred to as CSC administers accounts of merchants and customers, whose details and balance (or credit limitations) are maintained in a database by the CSC, among which are the merchant and customer in this example.

Upon receiving the first data communication message, the customer's and merchant's identification details are verified with reference to the data stored in the CSC database, and the transaction amount to be paid is compared with the balance of the customer's account, or his credit limitations.

At this stage, if there exist any problem or inconsistency, e.g. the merchant's or customer's identification, or the customer's balance are not verified, than an optional message may be transmitted to the POS, possibly indication the nature of the inconsistency or problem, and is displayed on a display means at the POS.

A second data communication message 7, which is in fact a authorization request, is then transmitted from the CSC to the customer's mobile phone, containing the transaction details, that are displayed on the phone's display, and the customer is prompted to authorize the transaction, by entering an approving or declining command (e g. press one or more of a preassigned keys), or requesting a PIN for authentication.

If there was an imposter pretending to conduct the transaction in the name of a real subscriber to the mobile transaction service (by providing an illegally or unlawfully obtained customer's identification), but without the real customer's mobile phone at his disposal, than the transaction process could be immediately halted at this stage, as the owner of the phone would suddenly receive a transaction authorization request, and upon realizing it was a fraud send a decline command. The process is further described assuming no such case has occurred.

A third communication message 8—an authorization message—is transmitted from mobile phone 1 to CSC 3, authorizing the transaction. In another preferred embodiment of the present invention the second and third communication messages are respectively voice request for authorization transmitted from CSC 3 to the customer's mobile phone and the customer voicing his authorization (such as him saying “I approve”) to a voice identification means at the CSC.

Both the second data communication and the third data communication messages are wireless transmissions conducted through the mobile telephony network 4 In the case of a GSM network, it may be desirable, and is even recommended, to use SMS data communication protocol, that is cheaper than usual air-time and much more secured.

A fourth communication 9 is conducted between CSC 3 and the merchant's POS, notifying the POS of the authorization of the transaction, and finally a fifth communication 10 is sent from POS 2 to CSC 3, finalizing the transaction (“closing the deal”). This last communication may be automated or manually activated by the merchant at the POS. In the latter case there still exists a chance for the customer to change his mind and ask the transaction to be cancelled. The POS may optionally be adapted to send a canceling communication, or another possible way would be to require that the closing communication be sent during a predefined period of time, after which the transaction will be cancelled anyway.

After the last communication has been received by the CSC, the merchant's account administered in the CSC is credited in the amount of the transaction and the customer's account with the CSC is debited accordingly.

Note that there may be some possible freedom in the order of the actions performed in the system, such that verification of the customer's balance may be performed in the CSC after the authorization communication 8 was sent by the customer and received in the CSC, but that could result in a futile step (the customer's authorization step), if for instance the customer's balance does not permit conducting the transaction.

Transaction cancellation or refunds, after the completion of the transaction, are done in the same manner with the amount entered with a negative sign.

The last communication (the deal closing) may be carried out instantly, or at a later time, depending on the actual billing time or other reasons. It may be desirable to accumulate transaction information on a predetermined number of transactions prior to the final communication to the CSC, or conduct the final communication at predetermined instances, such as periodically, once a day, once a week, or similar arrangement It may optionally be desirable to accumulate transaction information up to a predetermined sum, prior to the conduction of the final communication.

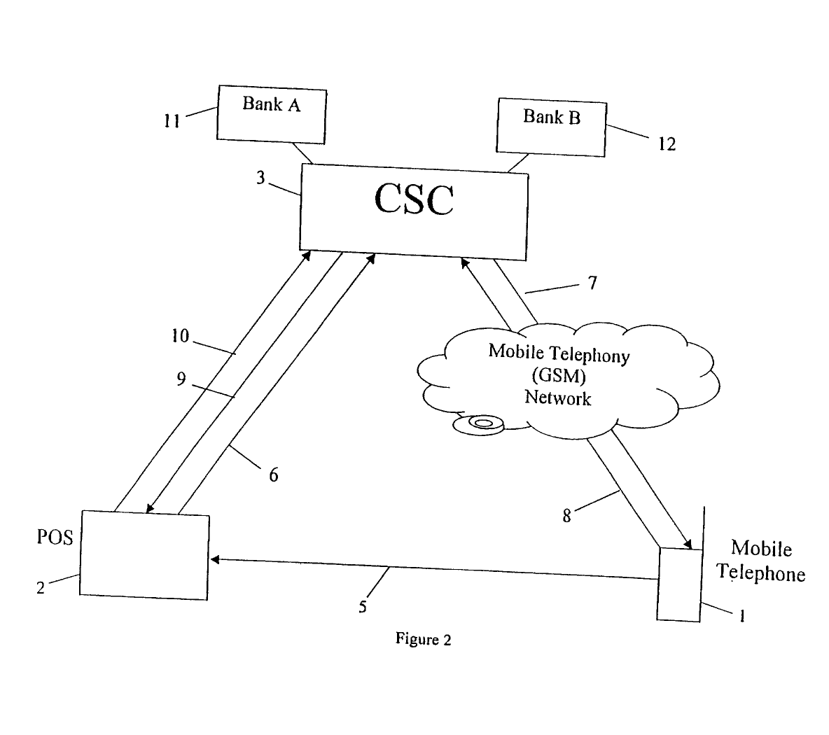

FIG. 2 illustrates a schematic diagram of a mobile transaction system in accordance with another preferred embodiment of the present invention. This embodiment is in fact similar to the one shown in FIG. 1, except that in this embodiment the merchant's and the customer's accounts are managed one in bank A 11 and one in Bank B 12. Banks A, B may also be any other financial institutions (such as credit providing companies, or other such institutions).

Reference is now made to FIG. 3 illustrating a schematic diagram of an administrating server, referred to as CSC (Cellular Service Center).

The CSC comprises communication interface to the mobile telephony network 21 (such as the GSM network of FIGS. 1 and 2), database 22 in which merchants' and customers' details, balance, credit limitations and any additional information details are stored, archive 23 (which may be in fact a part of the database 22) in which past transaction information is stored for reference, communication interface adapted to facilitate communication between the CSC to a plurality of merchant POSs, and a processing unit adapted to manage the merchant's and customer's accounts, communicate with POSs and with customer's mobile phones in the manner described herein, and administer verifications and finalizations of transactions, also in the manner described herein. Database 22 may also include additional (optional) information on customers preferences, special deals or discounts offered by specific merchants etc. In fact information on special discounts, or sales, may be transmitted to all the customers, or just to customers within the cell where a certain business is offering these discounts (using the cellular ability to track and locate the presence of cellular phones within a predetermined cell coverage area).

The CSC may optionally further comprise customer service support server, for clients' inquiries, interface to banks, or interface to any clearing house entity that is connected to the banks, billing system (S/W function) and interface to credit card companies.

The CSC may also further comprise supplementary added value services server, managing added value services such as and directly offering them to the CEP:

Advertisements that depend on time and/or place, per cell, and maybe be presented on the customers mobile phone.

Coupons that are dependent on time and/or place, per cell, and would be presented on the customers mobile phone.

Auctions and discounts that are dependent on time and/or place, per cell, and would be presented on the customers mobile phone.

Wireless Application Protocol (WAP) server.

Internet gateway facilitating communications with the Electronic-Commerce world as would a user with credit card.

Telephony gateway that communicate with the E-commerce world as a user with credit card.

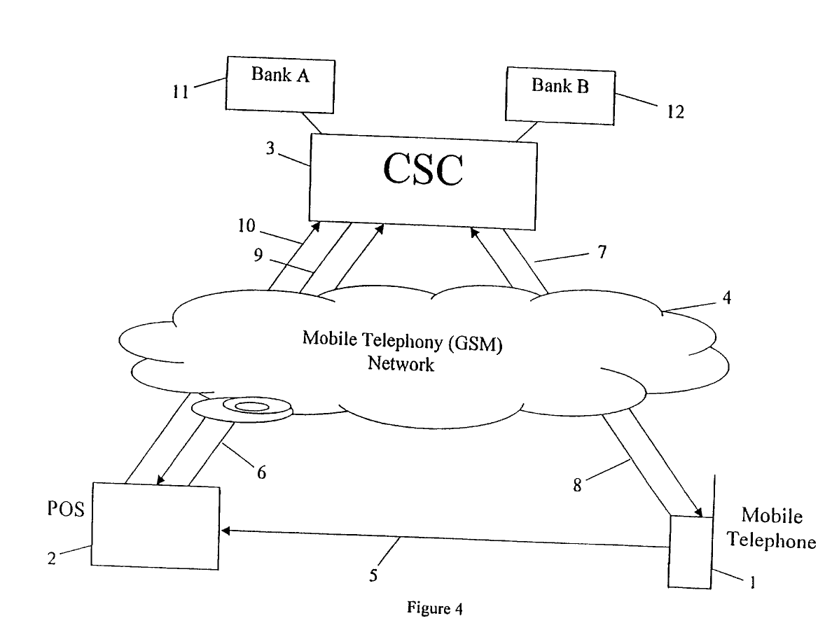

FIG. 4 illustrates a schematic diagram of a mobile transaction system in accordance with yet another preferred embodiment of the present invention. In this embodiment all communications between the POS 2 and CSC 3 and between the mobile phone 1 are conducted through the mobile telephony network 4 (i.e. all communications are wireless) As explained earlier it is preferable to have fast direct communication links between the administrating server and the communication unit, but wireless communication (such as communication via the mobile telephony network is optional.

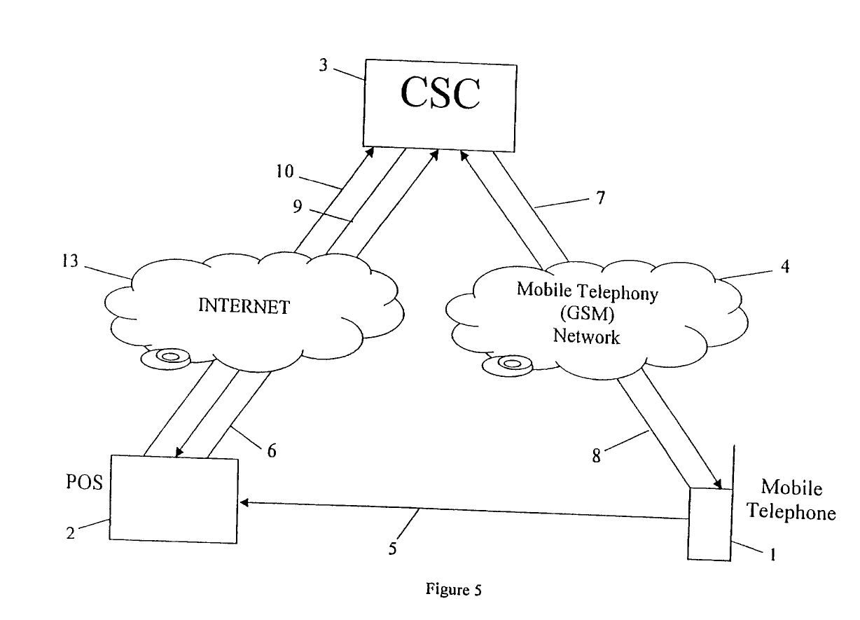

FIG. 5 is a schematic diagram of a mobile transaction system in accordance with yet another preferred embodiment of the present invention, designed for Internet (or similar network) transactions. Here communications 6, 9 and 10 (see explanation referring to FIG. 1) are conducted via the internet. In the case of Internet communication TCP/IP protocol is commonly considered, but other communication types are suitable too, such as LAN

FIG. 6 depicts a block diagram of typical design for a point-of-sale (the communication unit) in a mobile transaction system in accordance with a preferred embodiment of the present invention. The POS (or cellular GSM gateway—CGG) comprises communication interface 31 to a mobile telephony network, communication interface 32 to the CSC, database 37 for storing transaction information locally (such as transaction documentation required by law, or information for later proof of purchase), an optional printer 35, for printing out receipts or other forms of purchase proof, to be handed to the customer for his reference, or for the merchant's documentation, and a Central Processing Unit 33 which processes the information in the manner previously explained. A user interface 34, such as a keyboard and display, or similar input/output device, is provided for inputting necessary transaction details (primarily the transaction amount to be paid, but also other desired optional information too).

It is noted that wherever cash register is mentioned throughout this specification, it may be substituted by a plurality of cash registers, connected by network to a CGG, or to a CR adapted to perform the functions of a CGG.

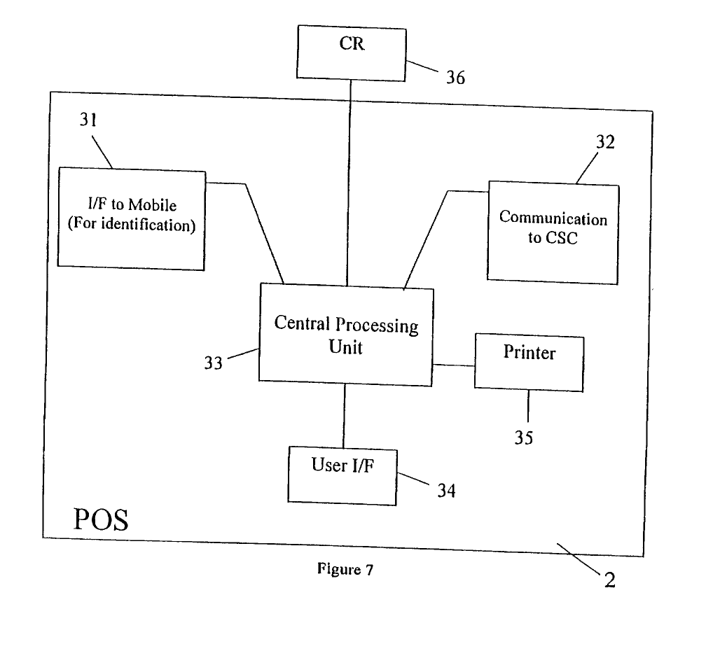

FIG. 7 depicts a block diagram of typical design for a point-of-sale in a mobile transaction system in accordance with a preferred embodiment of the present invention, cooperating with a cash register. In this embodiment, in contrast to the one shown in FIG. 6, the POS is an add-on feature to an existing cash register (CR) 36, and communicating with it, allowing input of the transaction details directly from the CR, instead of using user interface 34, and also storing past transaction information on the CR memory 37, instead of in a database within the POS. Since a standard CR is usually equipped with a printer, it is optional to omit the printer in this embodiment.

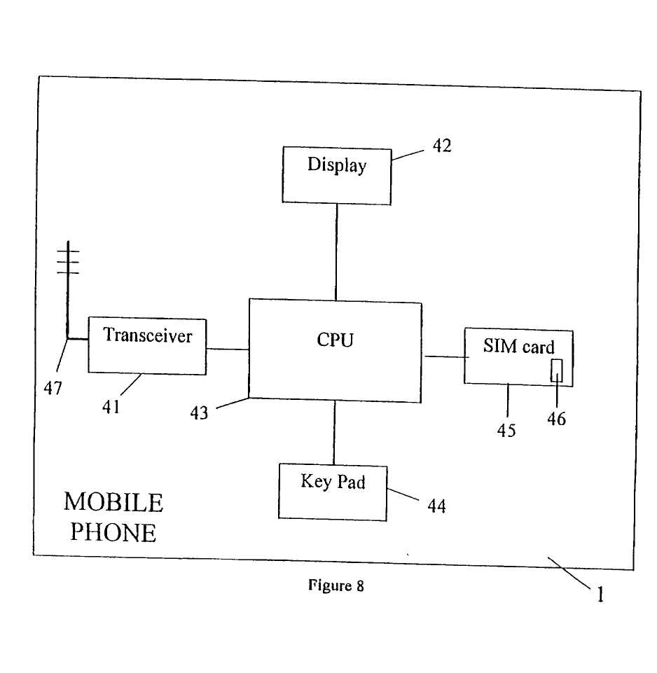

FIG. 8 depicts a block diagram of typical design for a mobile phone cooperating with a mobile transaction system in accordance with a preferred embodiment of the present invention. A cellular phone operating in a GSM telephony network generally comprises keypad 44 for entering commands, display 42 (such as LCD display), transceiver 41 for transmitting and receiving communications to and from the GSM telephony network connected to an antenna 47, a CPU 43 for processing the performing the phone's tasks, and SIM card 45 where personal information (such as phone numbers stored for future reference, details on the phone holder etc.). A SIM card can be programmed to include S/W applications, such as an application 46 facilitating the performance of the phone in a transaction system in accordance with a preferred embodiment of the present invention.

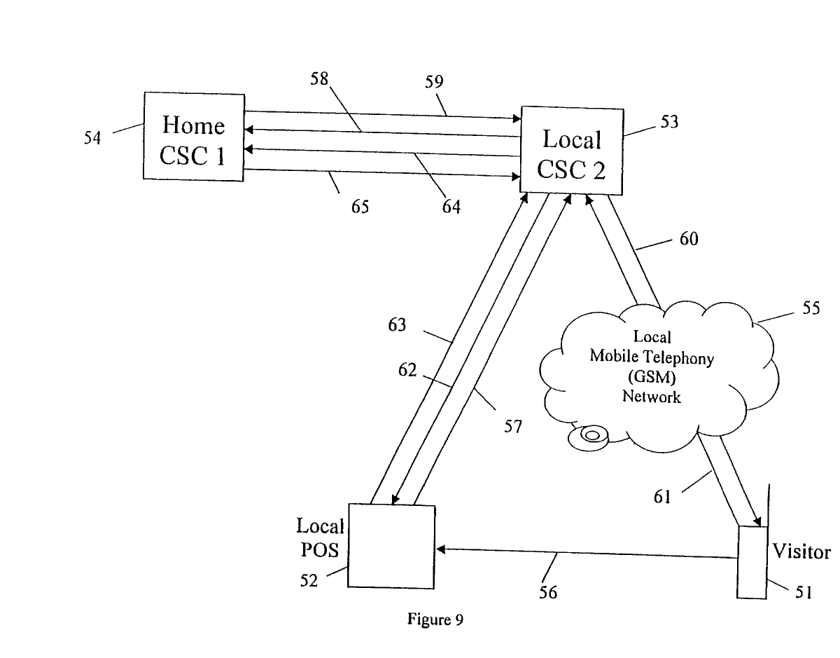

FIG. 9 illustrates international application of the mobile transaction system and method of the present invention.

It is an undisputed fact that roaming between cellular networks has become reality, with subscribers to one GSM telephony network move into areas covered by other GSM network, register to that other GSM network and use telephony services provided by the other network.

The purchase with the cellular transaction service maybe performed over different networks, over different cellular transaction operators, over different countries, with merchants strangers to the customer, or between any combinations of the above factors: network, country, cellular transaction service operator.

The concept presented herein is aimed at enabling the customer to use his mobile phone in different sites worldwide.

The Main advantages of this application are evident:

There would be no need for exchanging money physically.

No small unused foreign currency left in the purse after travelling abroad.

Convenience while traveling between countries.

Referring to FIG. 9, a visitor mobile phone 51 ,usually a customer of a GSM telephony network in his place of origin, is brought into the coverage are of a second, local, GSM telephony network 55. The visitor encounters a merchant's shop or place of business. Upon deciding to purchase a good or a service from that merchant, he chooses to pay through his mobile transaction service. Mobile phone 51 is adapted to operate in the cellular transaction system of the present invention, having a suitable application for that purpose.

The merchant, on his side, is provided with a POS, a cellular GMS gateway, provided with a bi-directional communication link to a local CSC 2 (53).

First, the customer identifies himself 56 providing to the merchant's point-of-sale (POS) 52 an ID number previously assigned to him and kept with the administrating server.

Once POS 52 has received the customer's (or his mobile phone) identification details in communication message 56, a first data communication message 57 containing the customer's ID, the merchant's ID (also previously assigned to him by the administrator of the system), and the sum to be paid (the “transaction details”), is transmitted to the local CSC 2 (53).

This first data communication message is sent via the communication link from POS 52 to CSC 2 (53)

Upon receiving the first data communication message, the customer's and merchant's identification details are verified. However, whereas the merchant's information is stored in the local CSC database, the visitor's account and balance information is stored with his own home CSC 1 (54). Therefore a second communication message 58 is sent from local CSC 2 to visitor's home CSC 1 (54), requesting verification on the visitor's identification and balance. Home CSC 1 (54) verifies the requested information, sending a verification in a third communication 59 back to local CSC 2 (53), and the transaction incorporated details (the visitor's info originating from his home CSC, and the local merchant's details and the amount to be paid) are transmitted in a fourth communication message 60 through the local GSM telephony network to the visitor's mobile phone for authorization, that is displayed on the phone's display, and the customer is prompted to authorize the transaction, by entering an approving or declining command or entering a PIN for authentication.

A fifth communication message 61—a authorization message—is transmitted from mobile phone 51 to local CSC 2 (53), authorizing the transaction.

Both communication messages to and from the visitor's mobile phone are sent via the local GSM telephony network

A sixth communication 62 is conducted between local CSC 2 and the merchant's POS 52, notifying the POS of the authorization of the transaction, and a seventh communication 63 is sent from POS 52 to CSC 2 (53), finalizing the transaction (“closing the deal”). Then a final transaction request is communicated 64 from local CSC 2 to home CSC 1, requesting transfer of currency, and this financial transfer 65 is finally conducted, debiting the visitor's account with the Home CSC, and crediting the local merchant's account with the local CSC

The implementation of the cellular transaction method of the present invention in this embodiment (involving two cellular networks) is in fact almost identical to the implementation of the method as described above, where only one local cellular network was involved, with apparent necessary adjustments, as explained above.

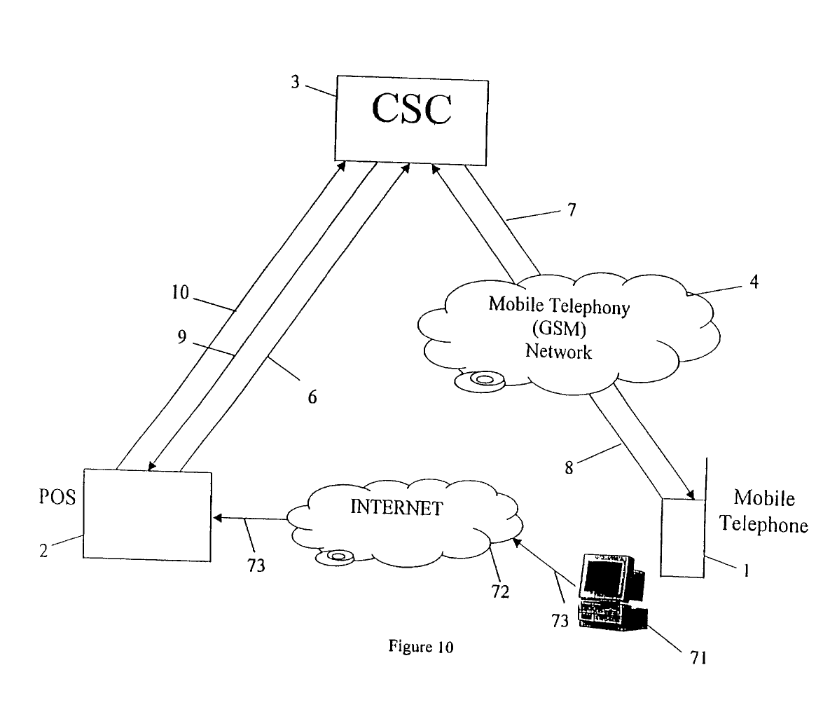

FIG. 10 illustrates a schematic diagram of a mobile transaction system in accordance with yet another preferred embodiment of the present invention, designed for Internet (or similar network) transactions.

Here some adjustments to the embodiments shown before were made to facilitate paying via the mobile transaction system for goods and services offered over the internet, or similar network.

The customer browses in the internet using his PC 71, communicating 73 with a POS 52 via the internet 72, upon deciding to purchase a certain good or service the customer provides the merchant's POS with identification details either through his PC, through the internet, the rest of the procedure is carried out as before, but this time, after the completion of the transaction an additional message may be communicated to the customer's mobile phone providing him with a storable proof of purchase (in the phones memory) for the customer's future reference.

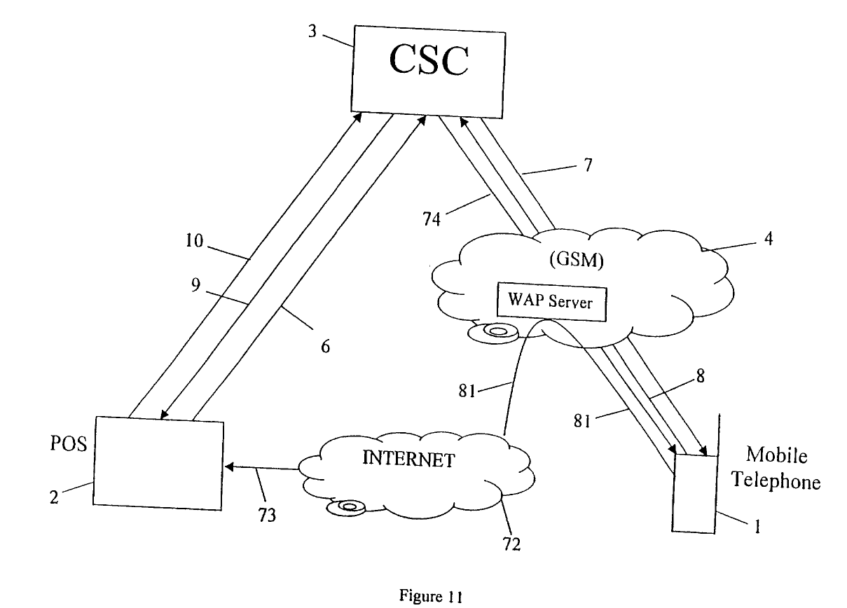

FIG. 11 illustrates a schematic diagram of a mobile transaction system in accordance with yet another preferred embodiment of the present invention, designed for Internet (or similar network) transactions, with the mobile phone used as a browsing platform. The embodiment in this figure differs to the previous one in only one aspect here the customer browses the internet directly 81 with his mobile phone (WAP technology is known to allow internet services in mobile phones).

The method of payment of the present invention may be also implemented with browsing capability of mobile phones (Nokia's 9000 series is an example of a mobile phone that is provided with a capability to connect to the internet). In this implementation the user will connect to an ISP through the cellular network using his mobile phone, and browse through internet pages. When he comes across an internet page offering sale of goods or services, he chooses to pay by the cellular transaction service, and selects this method on his mobile phone application.

The cellular transaction method may entirely substitute the credit card method of payment, eliminating the need to carry a credit card, and perform transactions using the cellular phone instead.

An optional feature in the cellular transaction application is adaptation of the application to enable the customer to check his balance in the CSC from remote, using his cellular phone.

Another optional feature is allowing the customer to replenish his account with the cellular transaction operator, for example by providing credit details through the cellular phone (vocally or through the cellular transaction application), or performing a transaction between his bank and the cellular transaction operators account with the CSC.

Yet another optional feature is producing reports on the current credit status and/or past transactions, which may be displayed on the cellular phone display. Detailed full report may be mailed or sent to the customer using any electronic media, including but not limited to internet communication.

The advantages method and system of the present invention in general are numerous:

The system offers the customer convenience, security, mobility, globality and discounts in performing purchases, On the other end it gives merchants convenience, secure way of receiving money and a way to attract clients.

The system is simple for use, and lets the customer pay bills and perform transactions using the mobile phone There's no need to carry cash, checks, debit or credit cards, nor to look for an ATM.

Loosing the cellular phone would not lead to money loss. The finder of the lost phone would not be able to use it. It would be very easy for the customer to block the service. The money is “in” the CSC.

It is anticipated that merchants will give discounts to cellular transaction service customers, as this method of payment ensures the provision of the transaction. The method and system of the present invention promote the increase in electronic sales and allow the existence of POS with no cash in the cash register.

The present invention may also be implemented in vending machines, limiting the need for cash disposal in the machine, and eliminating the need to produce change.

The system may be indeed operated and monitored by a commercial service provider, whose income would be derived from the shear volume of the transactions, as a certain percentage of the transactions.

It should be clear that the description of the embodiments and attached Figures set forth in this specification serves only for a better understanding of the invention, without limiting its scope as covered by the following claims.

It should also be clear that a person skilled in the art, after reading the present specification, could make adjustments or amendments to the attached Figures and above described embodiments that would still be covered by the scope of the invention as defined in the following claims.

1. A transaction system for conducting financial transactions, cooperating with a mobile telephony network adapted to provide telephony services to a plurality of mobile phones, said system comprising:
an administrating server adapted to administer accounts of merchants and customers, and adapted to communicate at a given time with at least one of the plurality of mobile phones of a customer via the mobile telephony network;
at least one of a plurality of communication units which are located at merchants' point of sale adapted to communicate with said administrating server;
wherein the communication unit is adapted to identify the mobile phone, and adapted to communicate to said administrating server a first communication message comprising transaction details, identifying the merchant, the customer and specifying an amount to be paid;
wherein said administrating server is adapted to communicate the transaction details in a second communication message via the mobile telephony network to the mobile phone for authorization by the customer, and adapted to receive authorization from the customer in a third communication message from the mobile phone via the mobile telephony network;
wherein said administrating unit is further adapted to communicate a transaction authorization in a fourth communication message to said communication unit;
wherein said communication unit is adapted to finalize the transaction by communicating a fifth communication message to said administrating server;
and wherein said administrating server is adapted, after receiving the finalizing message to debit the customer's account in the amount to be paid and credit the merchant's account accordingly.

2. A system as claimed in claim 1, wherein the mobile telephony network is a GSM network.

3. A system as claimed in claim 1, wherein the mobile phone is adapted to cooperate in said system by means of an application program which is a built-in hardware application or a software application.

4. A system as claimed in claim 1, wherein the mobile phone is adapted to cooperate in said system by means of an application program which is a built-in hardware application or a software application stored on a memory of the mobile phone memory or on a SIM card.

5. A system as claimed in claim 3 or claim 4, wherein the application program stores permanently personal parameters of the customer such as the customer's identification details, and enables sending and receiving wireless data communications and Inputting data through a keypad of the mobile phone, and viewing messages on a display of the mobile phone.

6. A system as claimed in claim 1, wherein communication between said administrating server and the mobile phone is conducted using SMS protocol.

7. A system as claimed in claim 1, wherein communication between said administrating server and the mobile phone is conducted using WAP protocol.

8. A system as claimed in claim 1, wherein the communication unit is adapted to identify the mobile phone by receiving an ID number from the customer.

9. A system as claimed in claim 1, wherein the communication unit is adapted to identify the mobile phone by receiving an ID number from the customer, who enters the ID number directly into said communication unit.

10. A system as claimed in claim 1, wherein the communication unit is adapted to identify the mobile phone by receiving an identifying RF signal from the mobile phone.

11. A system as claimed in claim 1, wherein the communication unit is adapted to identify the mobile phone by receiving an identifying arbitrary code or number generated by the mobile phone or by the administrating server, and transmitted to the administrating server for verification.

12. A system as claimed in claim 1, wherein the communication unit is adapted to identify the mobile phone by providing the mobile phone with identifiable feature or features, and providing said communication unit with suitable identifying means for receiving the identifiable features.

13. A system as claimed in claim 12, wherein the identifiable feature is a barcode, and the identifying means comprise barcode reader.

14. A system as claimed in claim 12, wherein the identifiable feature is a signal in the audio range, and the identifying means comprise audio receiver.

15. A system as claimed in claim 1, wherein said administrating server and communication unit intercommunicate through a point-to-point line or telephone lines or wireless communication link.

16. A system as claimed in claim 1, wherein the fifth communication message is carried out instantly.

17. A system as claimed in claim 1, wherein the fifth communication message is carried out after a predetermined number of transactions have been performed.

18. A system as claimed in claim 1, wherein the fifth communication message is carried out after a predetermined time has elapsed.

19. A system as claimed in claim 1, wherein the fifth communication message is carried out after a predetermined sum of transactions has been reached.

20. A system as claimed in claim 1, wherein the accounts of merchants and customers are managed in financial institutes, such as banks, credit providing companies and the like.

21. A system as claimed in claim 1, wherein said administrating server comprises communication interface to the mobile telephony network, a database which merchants' and customers' details, balance, credit limitations and any additional information details are stored, archive in which past transaction information is stored for reference, communication interface adapted to facilitate communication between the administrating server to a plurality of merchant communication units, and a processing unit adapted to manage the merchant's and customer's accounts, and communicate with the communication units and with customers mobile phones.

22. A system as claimed in claim 1, wherein communications between said administrating server and the communication unit are conducted via the internet.

23. A system as claimed in claim 1, wherein said communication unit comprises communication interface to the mobile telephony network, communication interface to the plurality of merchants' communication units, database for storing transaction information locally, a user interface, a printer, for printing out receipts or other forms of purchase proof, and a processing unit for controlling the performance of said communication unit

24. A transaction system for conducting financial transactions, cooperating with a first mobile telephony network adapted to provide telephony services to a plurality of mobile phones and at least one of a plurality of mobile phones of visitors originally registered with a second mobile telephony network , said system comprising:
a first administrating server adapted to administer accounts of merchants and customers, and adapted to communicate at a given time with at least one of the plurality of mobile phones of a customer via the mobile telephony network,
a second administrating server similar to the first administrating server, operating in the second mobile telephony network, administering accounts of the visitors and adapted to communicate with said first administrating server;
at least one of a plurality of communication units which are located at merchants' point of sale adapted to communicate with said first administrating server;
wherein the communication unit is adapted to identify the visitor's mobile phone, and adapted to communicate to said first administrating server a first communication message comprising transaction details, identifying the merchant, the visitor and specifying an amount to be paid;
wherein said first administrating server is adapted verify the visitors identification details and balance wioth the second administrating server, to communicate the transaction details in a second communication message via the mobile telephony network to the visitor's mobile phone for authorization by the visitor, and adapted to receive authorization from the visitor in a third communication message from the mobile phone via the mobile telephony network;
wherein said first administrating unit is further adapted to communicate a transaction authorization in a fourth communication message to said communication unit;
wherein said communication unit is adapted to finalize the transaction by communicating a fifth communication message to said first administrating server;
and wherein said first administrating server is adapted, after receiving the finalizing message to communicate with said second administrating server and facilitate debiting the visitor's account in the amount to be paid and credit the merchant's account accordingly.

25. A system as claimed in claim 1, wherein said communication unit is adapted to identify the mobile phone by way of supplying identification details to said communication unit via the internet.

26. A system as claimed in claim 25, wherein the mobile phone is provided with internet browsing capability.

27. A method of conducting transactions, incorporating with a mobile telephony network adapted to provide telephony services to a plurality of mobile phones, said method comprising the steps of:
1. providing an administrating server adapted to administer accounts of merchants and customers, and adapted to communicate at a given time with at least one of the plurality of mobile phones of a customer via the mobile telephony network;
2. providing at least one of a plurality of communication units which are located at merchants' point of sale adapted to communicate with said administrating server;
3. identifying of the mobile phone by said communication unit;
4. communicating a first communication message comprising transaction details, identifying the merchant, the customer and specifying an amount to be paid from said communication unit to said administrating server;
5. communicating the transaction details in a second communication message from the administrating server via the mobile telephony network to the mobile phone for authorization by the customer, and receiving authorization from the customer in a third communication message from the mobile phone via the mobile telephony network to said administrating server;
6. communicating a transaction authorization in a fourth communication message to from said administrating server said communication unit;
7. finalizing the transaction by communicating a fifth communication message from said communication unit to said administrating server;
8. debiting the customer's account in the amount to be paid and crediting the merchant's account accordingly.

28. A method as claimed in claim 27, the mobile telephony network is a GSM network.

29. A method as claimed in claim 27, wherein communicating between said administrating server and the mobile phone is conducted using SMS protocol.

30. A method as claimed in claim 27, wherein communicating between said administrating server and the mobile phone is conducted using WAP protocol.

31. A method as claimed in claim 27, wherein the step of identifying of the mobile phone by said communication unit is carried out by receiving an ID number from the customer.

32. A method as claimed in claim 27, wherein the step of identifying of the mobile phone by said communication unit is carried out by receiving an ID number from the customer, by him directly entering his ID into said communication unit.

33. A method as claimed in claim 27, wherein the step of identifying of the mobile phone by said communication unit is carried out by receiving an identifying RF signal from the mobile phone.

34. A method as claimed in claim 27, wherein the step of identifying of the mobile phone by said communication unit is carried out by receiving identifying arbitrary code or number generated by the mobile phone or by the administrating server, and transmitted to the administrating server for verification.

35. A method as claimed in claim 27, wherein the step of identifying of the mobile phone by said communication unit is carried out by providing the mobile phone with identifiable feature or features, and providing said communication unit with suitable identifying means for receiving the identifiable features.

36. A method as claimed in claim 35, wherein the identifiable feature is a barcode, and the identifying means comprise barcode reader.

37. A method as claimed in claim 27, wherein the step of identifying of the mobile phone by said communication unit is carried out by supplying identification details to said communication unit via the internet.

38. A method as claimed in claim 27, wherein communications between said administrating server and communication unit is conducted through a point-to-point line or telephone lines or wireless communication link.

39. A method as claimed in claim 27, wherein the fifth communication message is carried out instantly.

40. A method as claimed in claim 27, wherein the fifth communication message is carried out after a predetermined number of transactions have been performed.

41. A method as claimed in claim 27, wherein the fifth communication message is carried out after a predetermined time has elapsed.

42. A method as claimed in claim 27, wherein the fifth communication message is carried out after a predetermined sum of transactions has been reached.

43. A method as claimed in claim 27, wherein the accounts of merchants and customers are managed in financial institutes, such as banks, credit providing companies and the like.

44. A method as claimed in claim 27, wherein communications between said administrating server and the communication unit are conducted via the internet.

45. A method of conducting transactions, incorporating with a first mobile telephony network adapted to provide telephony services to a plurality of mobile phones and visitors mobile phones, originally registered to a second mobile telephony network, said method comprising the steps of:
1. providing a first administrating server adapted to administer accounts of merchants and customers, and adapted to communicate at a given time with at least one of the plurality of mobile phones of a customer via the mobile telephony network;
2. providing a second administrating server similar to the first administrating server, operating in the second mobile telephony network, administering accounts of the visitors and adapted to communicate with said first administrating server;
3. providing at least one of a plurality of communication units which are located at merchants' point of sale adapted to communicate with said first administrating server;
4. identifying the visitor's mobile phone by said communication unit;
communicating a first communication message comprising transaction details, identifying the merchant, the visitor and specifying an amount to be paid from said communication unit to said first administrating server;
5. verifying the visitors identification details and balance with the second administrating server;
6. communicating the transaction details in a second communication message from said first administrating server via the first mobile telephony network to the visitor's mobile phone for authorization by the visitor;
7. authorizing the transaction by the visitor in a third communication message from the mobile phone via the first mobile telephony network to said first administrating server;
8. communicating from said first administrating server a transaction authorization in a fourth communication message to said communication unit;
9. finalizing the transaction by communicating a fifth communication message from said communication unit to said first administrating server;
10. communicating between said first administrating server with said second administrating server and facilitating debiting the visitor's account in the amount to be paid and credit the merchant's account accordingly.

46. The system as claimed in claim 1, wherein said second and third communication messages are respectively voice request for authorization transmitted from said administrative server to the mobile phone of the customer and the customer voicing his authorization to a voice identification means at the administrative server.

47. The system as claimed in claim 24, wherein said second and third communication messages are respectively voice request for authorization transmitted from said administrative server to the mobile phone of the customer and the customer voicing his authorization to a voice identification means at the administrative server.

48. The method as claimed in claim 27, wherein said second and third communication messages are respectively voice request for authorization transmitted from said administrative server to the mobile phone of the customer and the customer voicing his authorization to a voice identification means at the administrative server.

49. The method as claimed in claim 45, wherein said second and third communication messages are respectively voice request for authorization transmitted from said administrative server to the mobile phone of the customer and the customer voicing his authorization to a voice identification means at the administrative server.
